(19) United States
(12) Patent Application Publication
(10) Pub. No.: US 2006/0290278 A1
(43) Pub. Date: Dec. 28, 2006

(54) Plasma display panel

(75) Inventor: Wootae Kim, Yongin-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/473,139

(22) Filed: Jun. 23, 2006

(30) Foreign Application Priority Data
Jun. 24, 2005 (KR) 10-2005-0055324

(51) Int. Cl. H01J 17/49

(52) U.S. Cl. 313/582

(57) ABSTRACT

A plasma display panel is disclosed. The plasma display panel includes a first substrate and a second substrate, a first electrode formed on the first substrate, a second electrode formed on the second substrate, and a dielectric layer formed on the first electrode. The dielectric layer includes a first region with a first permittivity and a second region with a second permittivity. The first region is formed on at least a part of the first electrode where the first electrode overlaps the second electrode.

This Non-provisional application claims priority under 35 U.S.C. §119(a) on Patent Application No. 10-2005-0055324 filed in Korea on Jun. 24, 2005 the entire contents of which are hereby incorporated by reference.

### BACKGROUND OF THE INVENTION

1. Field of the Invention

This document relates to a plasma display panel.

2. Description of the Background Art

Each of cells of a plasma display panel is filled with an inert gas containing a main discharge gas such as neon (Ne), helium (He) or a Ne—He gas mixture and a small amount of xenon (Xe). When a high frequency voltage is supplied to an electrode of the plasma display panel, the inert gas within the cells generates vacuum ultraviolet rays. The vacuum ultraviolet rays emit a phosphor formed between barrier ribs such that the image is displayed.

A driving signal is supplied to the electrode of the plasma display panel. The supply of the driving signal generates a reset discharge, an address discharge and a sustain discharge within discharge cells of the plasma display panel. The reset discharge is generated to uniformly form wall charges within the discharge cells. The address discharge is generated to select a discharge cell where light will be emitted. The sustain discharge is generated to emit light in the selected discharge cell. When the sustain discharge is generated within the discharge cell, the inert gas within the discharge cell generates vacuum ultraviolet rays. The vacuum ultraviolet rays emit the phosphor formed within the discharge cell such that the image is displayed.

A dielectric layer of the plasma display panel forms wall charges on the electrode such that a discharge state is maintained when supplying a firing voltage. The dielectric layer protects the electrode from ion impact. The thickness, permittivity, and light transmissivity of the dielectric layer, and the like, affect discharge efficiency and a firing voltage of the plasma display panel.

### SUMMARY OF THE INVENTION

According to an aspect, there is provided a plasma display panel comprising a first substrate and a second substrate, a first electrode formed on the first substrate, a second electrode formed on the second substrate, and a dielectric layer formed on the first electrode, wherein the dielectric layer comprises a first region with a first permittivity and a second region with a second permittivity, and the first region is formed on at least a part of the first electrode where the first electrode overlaps the second electrode.

According to another aspect, there is provided a plasma display panel comprising a substrate, a first electrode and a third electrode formed on the substrate, and a dielectric layer formed on the first electrode and the third electrode, wherein the dielectric layer comprises a first region with a first permittivity and a second region with a second permittivity, and the first region is formed on at least a part of the first electrode.

### BRIEF DESCRIPTION OF THE DRAWINGS

The embodiment of the invention will be described in detail with reference to the following drawings in which like numerals refer to like elements.

FIG. 1 illustrates a plasma display panel according to an embodiment of the present invention;

FIG. 2a is a cross-sectional view of the plasma display panel according to the embodiment of the present invention;

FIG. 2b is a plane view of the plasma display panel according to the embodiment of the present invention;

FIG. 3a is a cross-sectional view of a plasma display panel according to another embodiment of the present invention;

FIG. 3b is a plane view of the plasma display panel according to another embodiment of the present invention; and

FIGS. 4a to 4d illustrate changes in discharge efficiency and a firing voltage of the plasma display panel depending on the thickness and permittivity of an upper dielectric layer.

### DETAILED DESCRIPTION OF PREFERRED EMBODIMENTS

Embodiments of the present invention will be described in a more detailed manner with reference to the drawings.

A plasma display panel according to embodiments of the present invention comprises a first substrate and a second substrate, a first electrode formed on the first substrate, a second electrode formed on the second substrate, and a dielectric layer formed on the first electrode, wherein the dielectric layer comprises a first region with a first permittivity and a second region with a second permittivity, and the first region is formed on at least a part of the first electrode where the first electrode overlaps the second electrode.

The first permittivity of the first region may be greater than the second permittivity of the second region.

The first permittivity of the first region may range from 12 to 15, and the second permittivity of the second region may range from 10 to 12.

A ratio of the second permittivity to the first permittivity may range from 0.67 to 1.

The second region may cover the first region.

The first electrode may comprise a scan electrode, and the second electrode may comprise an address electrode.

A plasma display panel according to the embodiments of the present invention comprises a substrate, a first electrode and a third electrode formed on the substrate, and a dielectric layer formed on the first electrode and the third electrode, wherein the dielectric layer comprises a first region with a first permittivity and a second region with a second permittivity, and the first region is formed on at least a part of the first electrode.

A distance between the first electrode and the third electrode may range from 100 μm to 200 μm.

The first permittivity may be greater than the second permittivity.

The first permittivity of the first region may range from 12 to 15, and the second permittivity may range from 10 to 12.

A ratio of the second permittivity to the first permittivity may range from 0.67 to 1.

The second region may cover the first region.

The first electrode may comprise a scan electrode, and the third electrode may comprise a sustain electrode.

Hereinafter, exemplary embodiments of the present invention will be described in detail with reference to the attached drawings.

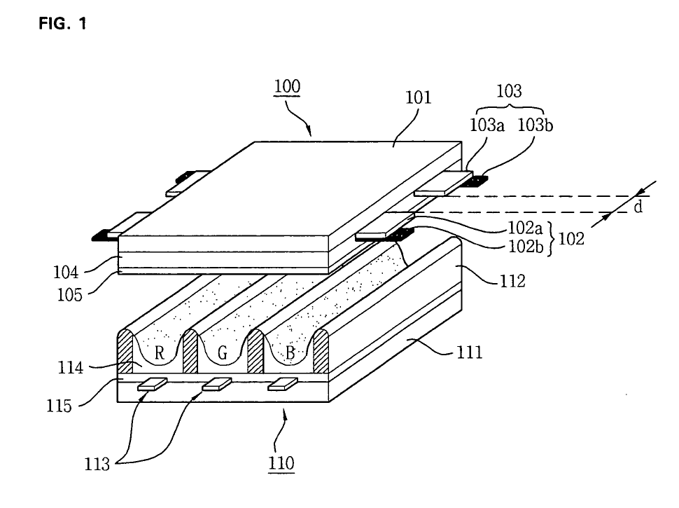

FIG. 1 illustrates a plasma display panel according to an embodiment of the present invention. As illustrated in FIG. 1, the plasma display panel according to the embodiment of the present invention comprises a front panel 100 and a rear panel 110. The front panel 100 on which an image is displayed comprises a front substrate 101. The rear panel 110 comprises a rear substrate 111. A scan electrode 102 and a sustain electrodes 103 are formed on the front substrate 101. An address electrode 113 is formed on the rear substrate 111 to intersect the scan electrode 102 and the sustain electrodes 103.

The scan electrode 102 and the sustain electrode 103 each comprise transparent electrodes 102a and 103a and bus electrodes 102b and 103b. The transparent electrodes 102a and 103a are formed on the front substrate 101, and are made of a transparent indium-tin-oxide (ITO) material. The bus electrodes 102b and 103b are formed on the transparent electrodes 102a and 103a, respectively, and are made of a metal material.

A distance d between the transparent electrode 102a of the scan electrode 102 and the transparent electrode 103a of the sustain electrode 103 may range from 100 μm to 200 μm. When the distance d between the transparent electrode 102a of the scan electrode 102 and the transparent electrode 103a of the sustain electrode 103 ranges from 100 μm to 200 μm, a discharge corresponding to positive column is generated in a discharge cell. Accordingly, discharge efficiency is improved.

An upper dielectric layer 104 is formed on the scan electrode 102 and the sustain electrode 103. The upper dielectric layer 104 limits a discharge current and provides insulation between the scan electrode 102 and the sustain electrode 103. The upper dielectric layer 104 comprises a first region with a first permittivity and a second region with a second permittivity. The first permittivity of the first region is greater than the second permittivity of the second region. The first permittivity of the first region may range from 12 to 15, and the second permittivity of the second region may range from 10 to 12. A ratio of the second permittivity to the first permittivity may range from 0.67 to 1.

The first region of the upper dielectric layer 104 is formed on at least a part of the scan electrode 102. The upper dielectric layer 104 will be described in detail below.

A protective layer 105 made of MgO is formed on an upper part of the upper dielectric layer 104.

A lower dielectric layer 115 is formed on an upper part of the address electrode 113. Barrier ribs 112 are formed on the lower dielectric layer 115 to form discharge cells. A phosphor layer 114 is formed between the barrier ribs 112. The phosphor layer 114 generates visible light with one of red, green and blue during the generation of the discharge. The first region of the upper dielectric layer 104 is formed on at least a part of the scan electrode 102 where the scan electrode 102 overlaps the address electrode 113.

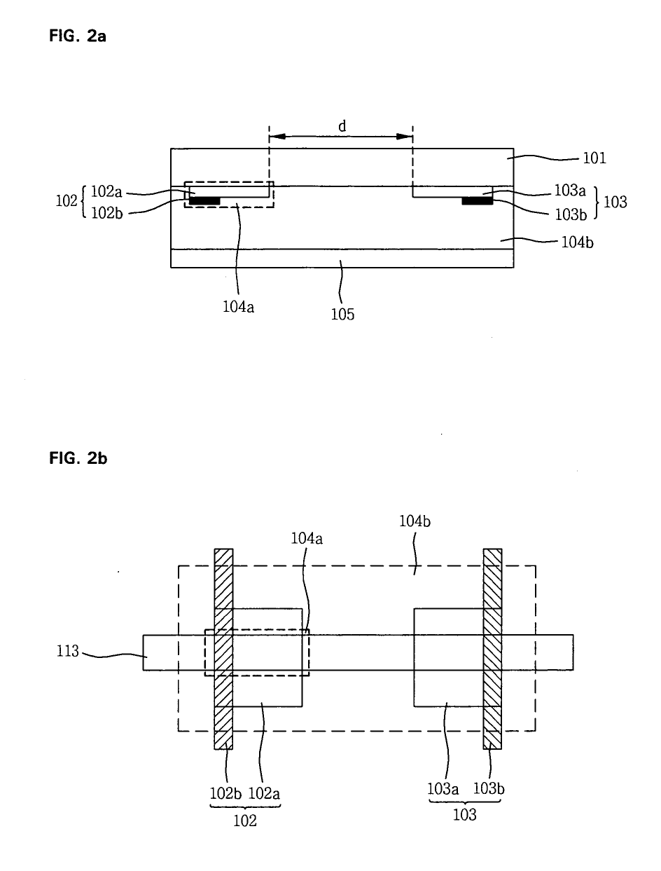

FIG. 2a is a cross-sectional view of the plasma display panel according to the embodiment of the present invention. As illustrated in FIG. 2a, the transparent electrodes 102a and 103a and the bus electrodes 102b and 103b are formed on the front substrate 101. The upper dielectric layer 104 is formed on the scan electrode 102 and the sustain electrode 103. A first region 104a, with the first permittivity, of the upper dielectric layer 104 is formed on at least a part of the scan electrode 102. A second region 104b, with the second permittivity, of the upper dielectric layer 104 covers the first region 104a of the upper dielectric layer 104. The first permittivity of the first region 104a is greater than the second permittivity of the second region 104b. The first permittivity of the first region 104a may range from 12 to 15, and the second permittivity of the second region 104b may range from 10 to 12. A ratio of the second permittivity to the first permittivity may range from 0.67 to 1.

FIG. 2b is a plane view of the plasma display panel according to the embodiment of the present invention. As illustrated in FIG. 2b, the address electrode 113 is formed to intersect the scan electrode 102 and the sustain electrode 103. The first region 104a of the upper dielectric layer 104 may be formed on at least a part of the scan electrode 102 where the scan electrode 102 overlaps the address electrode 113.

When the first region 104a, with the first permittivity, of the upper dielectric layer 104 is formed on at least a part of the scan electrode 102 where the scan electrode 102 overlaps the address electrode 113, a firing voltage required in an address discharge decreases. Address discharge delay decreases and efficiency of the address discharge increases due to the low firing voltage of the address discharge. Further, since efficiency of a sustain discharge increases due to an increase in the efficiency of the address discharge, discharge efficiency of the plasma display panel increases.

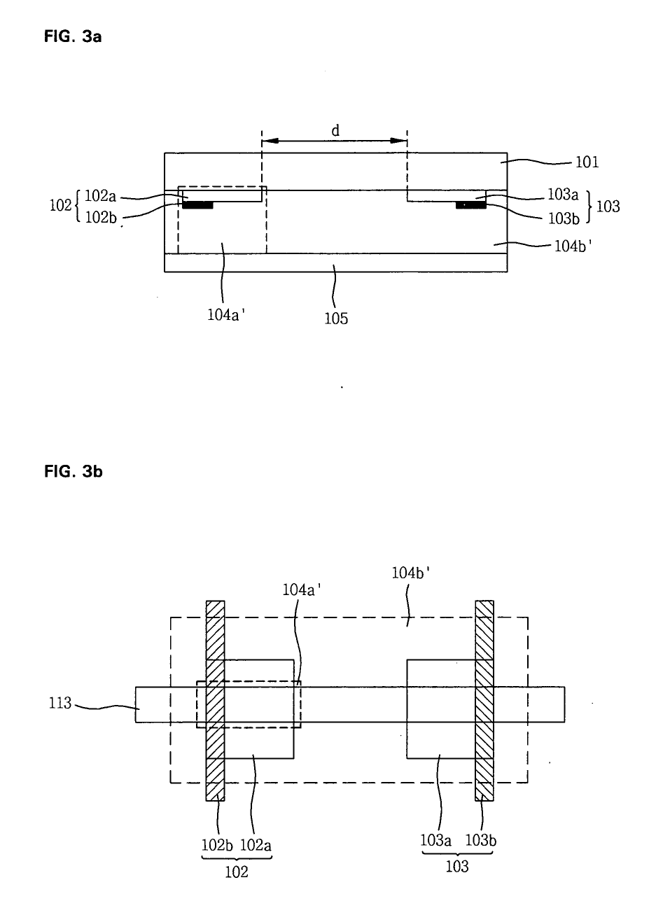

FIG. 3a is a cross-sectional view of a plasma display panel according to another embodiment of the present invention. As illustrated in FIG. 3a, a first region 104a′, with a first permittivity, of an upper dielectric layer 104 is formed on at least a part of a scan electrode 102. A second region 104b′, with a second permittivity, of the upper dielectric layer 104 does not cover the first region 104a′of the upper dielectric layer 104. The first permittivity of the first region 104a′is greater than the second permittivity of the second region 104b′. The first permittivity of the first region 104a′may range from 12 to 15, and the second permittivity of the second region 104b′may range from 10 to 12. A ratio of the second permittivity to the first permittivity may range from 0.67 to 1.

FIG. 3b is a plane view of the plasma display panel according to another embodiment of the present invention. As illustrated in FIG. 3b, an address electrode 113 is formed to intersect the scan electrode 102 and the sustain electrode 103. The first region 104a′of the upper dielectric layer 104 may be formed on at least a part of the scan electrode 102 where the scan electrode 102 overlaps the address electrode 113.

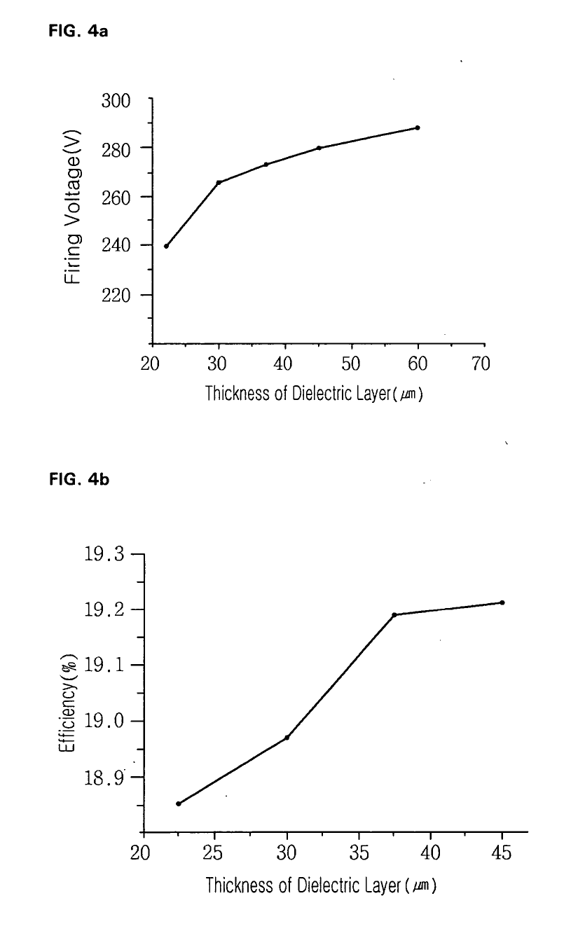

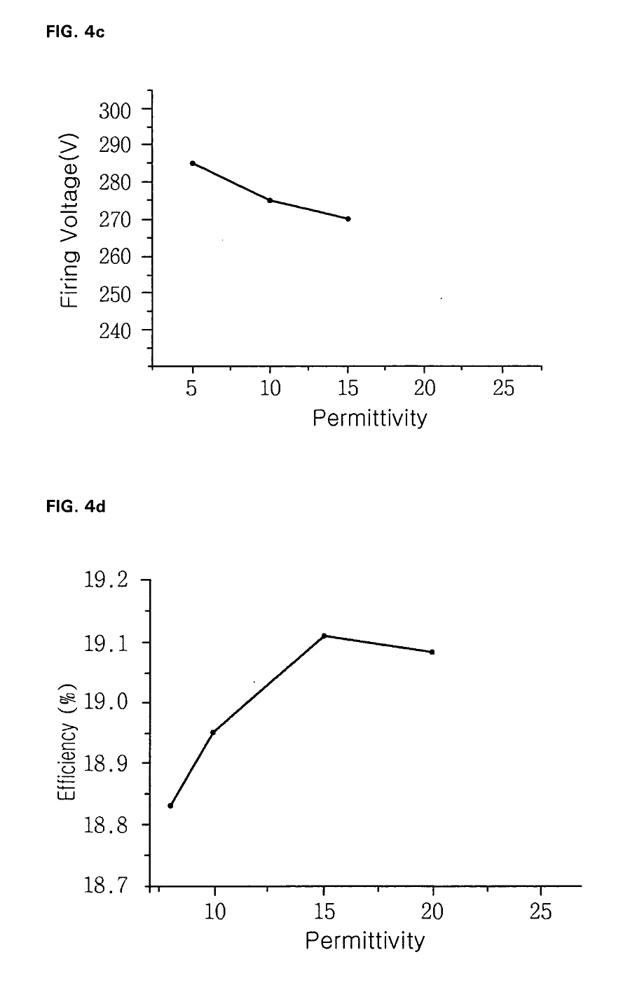

FIGS. 4a to 4d illustrate changes in discharge efficiency and a firing voltage of the plasma display panel depending on the thickness and permittivity of an upper dielectric layer.

As illustrated in FIG. 4a, the thickness of the upper dielectric layer is proportional to the firing voltage of the plasma display panel. As illustrated in FIG. 4b, the thickness of the upper dielectric layer is proportional to the discharge efficiency of the plasma display panel. As illustrated in FIG. 4c, the permittivity of the upper dielectric layer is inversely proportional to the firing voltage of the plasma display panel. As illustrated in FIG. 4d, the permittivity of the upper dielectric layer is proportional to the discharge efficiency of the plasma display panel.

In other words, as the thickness of the upper dielectric layer increases, the firing voltage and the discharge efficiency of the plasma display panel increase. Further, as the permittivity of the upper dielectric layer increases, the firing voltage of the plasma display panel decreases and the discharge efficiency of the plasma display panel increases.

Table 1 indicates the firing voltage and the discharge efficiency of the plasma display panel depending on the permittivity of the upper dielectric layer.

TABLE 1

| | | | | | η | T × η |
|---|---|---|---|---|---|---|
| Structure | ε | T (%) | V (V) | η (%) | (lm/W) | (lm/W) |
| I | 12.8 | 71.03 | 279 | 18.7 | 2.18 | 1.55 |
| II | 9 | 80.69 | 283 | 18.2 | 2.11 | 1.70 |
| III | 12.8/9 | 75.86 | 275 | 18.7 | 2.18 | 1.65 |
| IV | 9/12.8 | 75.86 | 289 | 18.2 | 2.10 | 1.59 |

In Table 1, ε indicates permittivity, T light transmissivity, V a firing voltage, and η efficiency of light depending on the permittivity ε The light transmissivity T indicates output light to incident light with respect to light emitted through the dielectric layer, in terms of percentage. The efficiency of light η indicates efficiency of light emitted depending on the permittivity ε, in terms of percentage and in terms of velocity of light emitted per 1 W. A value (T×η) of multiplying the light transmissivity T by the efficiency of light η indicates the discharge efficiency of the plasma display panel.

The structures I and II indicate a case where the upper dielectric layer has one permittivity. As the permittivity of the upper dielectric layer increases, the light transmissivity, the firing voltage and the discharge efficiency decrease and the efficiency of light increases.

The structures III and IV indicate a case where the upper dielectric layer has two different permittivities. In the structure II, the first region and the second region of the upper dielectric layer formed on the scan electrode have the first permittivity of 12.8 and the second permittivity of 9, respectively. On the contrary, in the structure IV, the first region and the second region of the upper dielectric layer formed on the scan electrode have the first permittivity of 9 and the second permittivity of 12.8, respectively.

As is apparent from FIGS. 4a to 4d and Table 1, in the plasma display panel according to the embodiments of the present invention, while the firing voltage of the plasma display panel decreases, the efficiency of light and the discharge efficiency of the plasma display panel increase and the discharge delay also decreases.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display panel comprising:
a first substrate and a second substrate;
a first electrode formed on the first substrate;
a second electrode formed on the second substrate; and
a dielectric layer formed on the first electrode,
wherein the dielectric layer comprises a first region with a first permittivity and a second region with a second permittivity, and the first region is formed on at least a part of the first electrode where the first electrode overlaps the second electrode.

2. The plasma display panel of claim 1, wherein the first permittivity of the first region is greater than the second permittivity of the second region.

3. The plasma display panel of claim 1, wherein the first permittivity of the first region ranges from 12 to 15, and the second permittivity of the second region ranges from 10 to 12.

4. The plasma display panel of claim 1, wherein a ratio of the second permittivity to the first permittivity ranges from 0.67 to 1.

5. The plasma display panel of claim 1, wherein the second region covers the first region.

6. The plasma display panel of claim 1, wherein the first electrode comprises a scan electrode, and the second electrode comprises an address electrode.

7. A plasma display panel comprising:
a substrate;
a first electrode and a third electrode formed on the substrate; and
a dielectric layer formed on the first electrode and the third electrode,
wherein the dielectric layer comprises a first region with a first permittivity and a second region with a second permittivity, and the first region is formed on at least a part of the first electrode.

8. The plasma display panel of claim 7, wherein a distance between the first electrode and the third electrode ranges from 100 μm to 200 μm.

9. The plasma display panel of claim 7, wherein the first permittivity is greater than the second permittivity.

10. The plasma display panel of claim 7, wherein the first permittivity of the first region ranges from 12 to 15, and the second permittivity of the second region ranges from 10 to 12.

11. The plasma display panel of claim 7, wherein a ratio of the second permittivity to the first permittivity ranges from 0.67 to 1.

12. The plasma display panel of claim 7, wherein the second region covers the first region.

13. The plasma display panel of claim 7, wherein the first electrode comprises a scan electrode, and the third electrode comprises a sustain electrode.
